(19) United States
(12) Patent Application Publication
(10) Pub. No.: US 2010/0252631 A1
(43) Pub. Date: Oct. 7, 2010

(54) HIGH SPEED CONTACTLESS COMMUNICATION

(75) Inventor: Walter Kargl, Graz (AT)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/416,441

(22) Filed: Apr. 1, 2009

(51) Int. Cl. G06K 7/04

(52) U.S. Cl. 235/444

(57) ABSTRACT

A contactless reader including a crystal oscillator configured to generate a first signal having a first frequency, a phase-locked loop configured to generate a crystal-accurate second frequency derived from the first frequency of the first signal, and a signal generator configured to generate a carrier signal having the crystal-accurate second frequency.

### BACKGROUND

An integrated circuit card (“IC card”), smart card, or chip card is a pocket-sized card with an integrated circuit that can process information. Implicitly, these pocket-sized cards can receive an input which is processed and subsequently delivered as an output. A contactless card or proximity card is a specific type of IC card, namely, a contactless integrated circuit device that can be used for applications such as security access or payment systems. Proximity cards operate on the basis of communication by an electromagnetic field with a read and/or write interrogating device, generically referred to as a reader. In other configurations, IC cards have also been designed to communicate with external devices such as a host personal computer, smart card adapters and connectors, and the like.

In proximity card applications, the reader typically transmits a carrier signal which creates an electromagnetic field or “H-field”. This carrier signal can serve on the one hand to power the contactless card, which is derived by converting the electromagnetic field into a DC voltage, and on the other hand to initiate a communication between the card and the reader according to an established communication protocol. For example, if data is modulated on the carrier signal, the integrated circuit in the card can read this data and use it appropriately. Communication protocols between a contactless card and a reader have been described, for example, in ISO standards 14443 A/B, 15693, and/or 18000. Conventional proximity card applications, such as those implementing a protocol defined by ISO standard 14443, operate at a relatively low communication speed, typically less than 10 Mbit/s (“megabit per second”).

In contrast, wireless local area networks (“WLAN”), which are battery or line powered, are capable of transmitting data at a much higher speed. IEEE 802.11, and specifically 802.11b which is often described interchangeably as “Wi-Fi”, is a set of standards for WLAN computer communication. The protocols defined by these standards enable data communication at speeds much faster than those accomplished under ISO standard 14443. Wireless data communication using Wi-Fi technology may be 100 Mbit/s or faster. To enable this high speed communication, devices employing Wi-Fi technology typically utilize crystal oscillators, which can generate very precise and stable, i.e., “crystal-accurate”, frequencies.

A crystal oscillator is an electronic circuit that uses the mechanical resonance of a vibrating crystal of piezoelectric material to create an electrical signal with a very precise frequency. Namely, crystal oscillators operate with very low phase noise since the crystal mostly vibrates in one axis. Moreover, the crystal oscillator is capable of generating electrical oscillation of a natural frequency within a range of around 1 kHz to 100 MHz. The output frequency can further be a multiple of the resonance, called an overtone frequency. Additionally, the “crystal-accurate” frequency and high Q factor that crystal oscillators provide can be used to stabilize frequencies for wireless transmitters/receivers. One drawback of crystal oscillators, however, is that they are a relatively large and expensive electronic component. Thus, while crystal oscillators have been used in applications such as personal computers, mobile phones, and video game consoles, these components are undesirable for smaller devices such as smart cards.

### BRIEF DESCRIPTION OF THE DRAWINGS

FIG. 1 illustrates a block diagram of the wireless system in accordance with an exemplary embodiment.

FIG. 2 illustrates a detailed diagram of the card reader in accordance with an exemplary embodiment.

FIG. 3A illustrates a detailed block diagram of one embodiment of a contactless card in accordance with an exemplary embodiment.

FIG. 3B illustrates a detailed block diagram of another embodiment of a contactless card in accordance with an exemplary embodiment.

FIG. 4 illustrates a flowchart for a method for high speed communication.

FIG. 5 illustrates a flowchart for another method for high speed communication.

FIG. 6 illustrates a flowchart for a method for high speed communication operating in hybrid mode.

### DETAILED DESCRIPTION

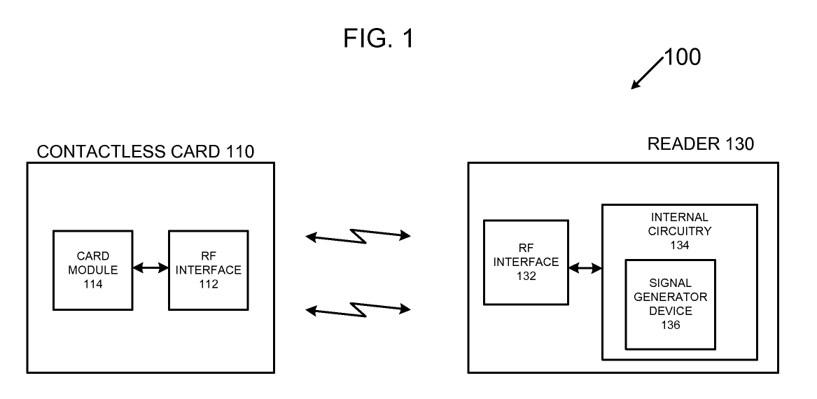

FIG. 1 shows a block diagram of the wireless system 100. Wireless system 100 comprises a contactless card 110, also known as a chip card, smart card, RFID tag, or proximity IC card (PICC), and a reader 130, also known as a proximity coupled device (PCD). Contactless card 110 operates on the basis of communication with reader 130 by a carrier signal generated by reader 130.

As shown, contactless card 110 comprises a radio frequency (“RF”) interface 112 and a card module 114. Reader 130 includes an RF interface 132 that enables data communication between contactless card 110 and reader 130. As will be described in more detail below, reader 130 further includes internal circuitry 134 that, in conjunction with an induction coil (not shown) of RF interface 132, transmits a carrier signal which may include modulated data. The internal circuitry 134 further utilizes a signal generator device 136 that is configured to generate the carrier signal for high-speed data communication and therefore define the frequency at which that carrier signal is transmitted.

RF interface 112 of contactless card 110 also includes an induction coil (not shown) that detects the electromagnetic field when contactless card 110 is moved into proximity with reader 130. Presuming data is modulated on the carrier signal, card module 114 includes components enabling contactless card 110 to read the modulated data from the carrier signal and use it accordingly. It should be understood that RF interface 112 and RF interface 132 each have antennas (not shown) configured to transmit and receive the carrier signal.

Similar to reader 130, contactless card 110 comprises electronic components that are located within card module 114 and are configured to generate a response signal that can be modulated onto the carrier signal. This response signal is transmitted from the induction coil in RF interface 112 and subsequently detected by the induction coil in RF interface 132 of reader 130. Once received by reader 130, the response signal can be processed by internal circuitry 134.

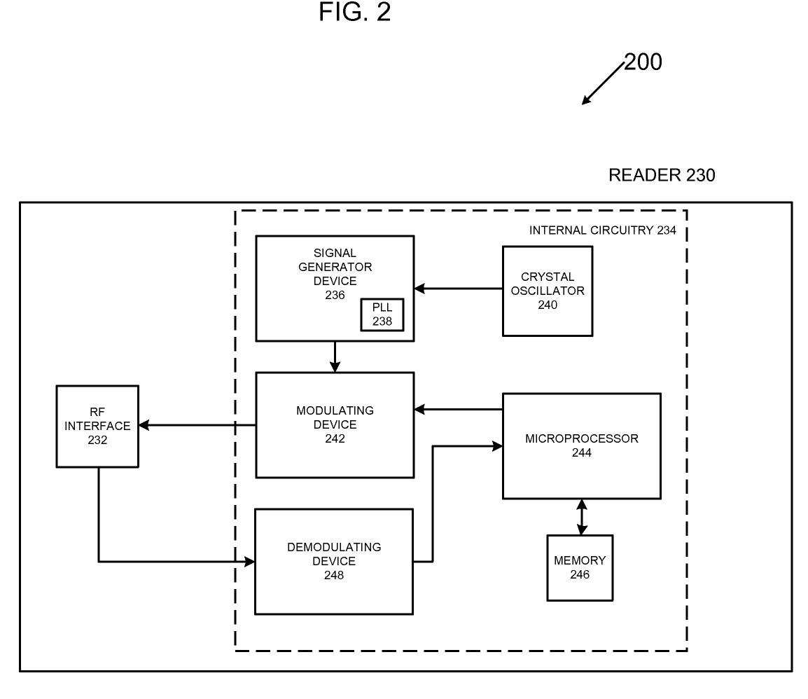

FIG. 2 shows a detailed block diagram 200 of the card reader. Reader 230 includes an RF interface 232 that employs the aforementioned induction coil (not shown) and at least one antenna (not shown) capable of transmitting and receiving a carrier signal. Furthermore, internal circuitry 234 is coupled to RF interface 232 and comprises, among other components, signal generator device 236, crystal oscillator 240, modulating device 242, microprocessor 244 or the like, memory 246 and a demodulating device 248. It should be understood that additional components that are commonly found in card readers, such as amplifiers, A/D converters, I/O devices, rectifiers or the like, are contemplated. Such components have not been described in detail so as not to unnecessarily obscure the description.

Specifically, crystal oscillator 240 is utilized by card reader 230 to generate a first signal to be input to signal generator device 236. This first signal has a first frequency that, in an exemplary embodiment, is 13.56 MHz in accordance with ISO 14443. Using the mechanical resonance of a vibrating crystal of piezoelectric material, crystal oscillator 240 creates the first signal with a frequency that is “crystal-accurate” (i.e., very stable and precise). As should be understood, the 13.56 MHz carrier signal produces a 13.56 MHz H-Field, which is also “crystal-accurate”.

It is noted that the application is not limited to the first frequency of the first signal being 13.56 MHz. This first frequency may lie within the Low Frequency (LF) range, the High Frequency (HF) range, or within any ISM (industrial, scientific and medical) frequency range. For example, low frequencies such as 125 kHz or 134 kHz or high frequencies in accordance with ISO 15693 or ISO 18000 are some acceptable frequencies.

Referring back to FIG. 2, signal generator device 236 is coupled to crystal oscillator 240 and is configured to generate a carrier signal used for high-speed data communication with a contactless card. In an embodiment, signal generator device 236 comprises phase-locked loop 238. Once the first frequency for the first signal is defined, the first signal is input to the phase-locked loop 238 to generate the second frequency. Phase-locked loop 238 responds to the phase and frequency of both the first signal and a reference signal to automatically raise the frequency of a controlled oscillator until it matches the reference signal in both frequency and phase. The output frequency of the phase-locked loop 238 defines the frequency of the carrier signal generating by signal generator device 236, which is to be used for high-speed data communication. Because crystal oscillator 240 defines the first signal with a frequency that is “crystal-accurate”, the frequency of the carrier signal will also be “crystal-accurate”.

The frequency of the carrier signal is greater than that of the first signal. Because the application enables contactless cards to operate in much higher frequency ranges at crystal-accurate frequencies, the contactless cards can communicate with card readers at USB communication speeds, such as those of USB 1.0 having a data rate of up to 1.5 Mbit/s, USB 1.1 having a data rate of up to as 12 Mbit/s, USB 2.0 having a data rate of up to 480 MBit/s, etc., or Wi-Fi standards as described above. Thus, for example, if the frequency of the first signal is in the HF range, then the frequency of the carrier signal may be, for example, in the microwave frequency range, or any other frequency deemed suitable by the system designer for the intended purpose. Of course it is also possible for the frequency of the carrier signal to be less than the frequency of the first signal, but such a design is not a primary focus of this application.

Since the frequency of the carrier signal for high-speed data communication is controlled by signal generator device 236, which is capable of outputting the carrier signal in, for example, the microwave frequency range, data can be transmitted via the carrier signal at high speeds such as 100 Mbit/s or faster. These speeds are similar to communication protocols defined by Wi-Fi standards, USB technologies, or the like. By implementing crystal oscillator 240 in reader 230 and not in the contactless card, the overall size of the contactless card is minimized. Moreover, because the precision and stability of crystal oscillator 240 directly correlates with the cost of the crystal used, employing crystal oscillator 240 in card reader 230, and not in each contactless card, helps reduce the overall cost of system 100.

Furthermore, as shown in FIG. 2, signal generator device 236 is coupled to a modulating device 242, which is also coupled to microprocessor 244. The microprocessor 244 is further coupled to memory 246, which may consist of ROM provided to store software necessary to operate card reader 230, RAM provided to temporarily store various data, and/or EEPROM (“Electrically Erasable PROM”) provided to store data which are read or rewritten by card reader 230.

In operation, the software executed by microprocessor 244 controls reader 230, and specifically, the defined application of reader 230 such as a security access or a payment system. If execution of the software dictates that data in memory 246 is to be transmitted to the contactless card, that data is first sent to the modulating device 242. Modulating device 242 is configured to modulate the carrier signal generated by the signal generator device 236 with a data signal received from microprocessor 244. Because this carrier signal is generated using phase-locked loop 238, the frequency of the carrier signal can be significantly higher than the HF range, such as in the microwave frequency range, while maintaining both the “crystal-accurate” precision and strength of the original first signal. As a result, reader 230 and contactless card 110 can communicate data at a very fast speed, such as 100 Mbit/s or more.

Reader 230 further comprises a demodulating device 248 that is coupled to RF interface 232 and microprocessor 244. Accordingly, when RF interface 232 receives a modulated response signal from a contactless card, demodulating device 248 will demodulate the signal and transfer the demodulated data to microprocessor 244 to be used accordingly.

While the exemplary embodiment of reader 230 enables communication with contactless cards in high-speed communication modes, existing infrastructures can employ the foregoing communication techniques through a hybrid mode. The hybrid mode is essentially a combination of standard high frequency radio communication based on standards such as ISO 14443, 15693 or proprietary versions, and communications based on high speed standards such as WLAN. When operating in the hybrid mode, an existing card reader 230 initiates communication with one or more contactless cards using the first signal as a carrier signal at the lower first frequency, and at some time after communication is established, increases the communication speed by employing the aforementioned techniques.

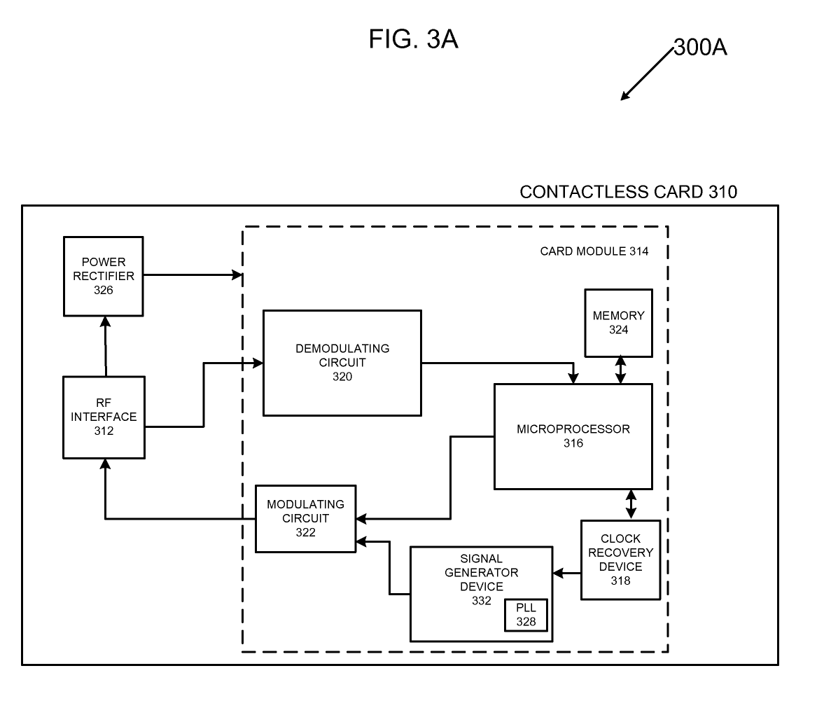

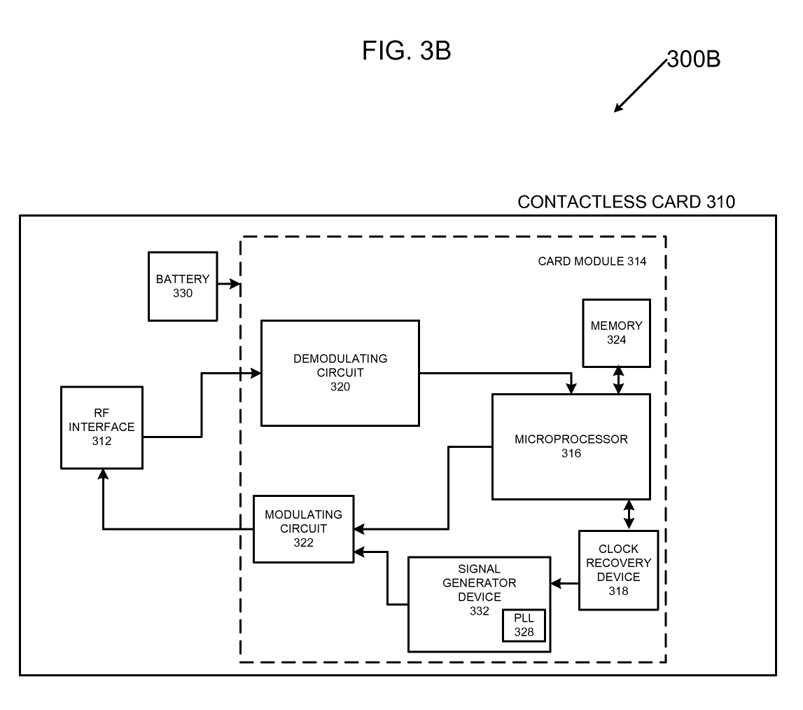

FIG. 3A shows a detailed block diagram 300A of one embodiment of the contactless card. Specifically, contactless card 310 includes RF interface 312, battery 326 and card module 314. RF interface 312 further includes an at least one antenna (not shown) configured to match at least the frequencies of the signals transmitted by the card reader, and, therefore, is capable of transmitting and receiving the high speed carrier signal. The one or more antennas may therefore be tuned to both the frequency of the first signal and the frequency of the carrier signal.

Existing contactless cards may be used enjoying the foregoing communication techniques with little or no modification. Specifically, if the existing antenna of a contactless card is a separate component from the integrated circuit, this antenna may be replaced or supplemented with a new antenna matched to the frequency of the high speed carrier signal. Alternatively, if the antenna is integrated in the integrated circuit of the contactless card, no physical modification is necessary to the contactless card. However, it should be understood that software may be loaded onto the contactless card to enable high speed communication using the inventive techniques.

Referring back to FIG. 3A, RF interface 312 is further coupled to card module 314. Card module 314 includes microprocessor 316, clock recovery device 318, demodulating circuit 320, modulating circuit 322 and memory 324. Power rectifier 326 is coupled to RF interface 312 and card module 314. Accordingly, when the induction coil of RF interface 312 detects the 13.56 MHz H-Field generated by the first signal, the power rectifier 326 converts this field to DC voltage. The DC voltage is in turn provided to power the card module 314 and all other components as necessary. If a battery (not shown) is provided in contactless card 310, the DC voltage may also be used to charge the battery. It should be understood that additional components common to smart/proximity card, such as security logic devices, additional rectifiers, etc., can be included in card module 314. Memory 324 of contactless card 310 can consist of ROM provided to store software necessary to operate contact card 310, RAM provided to temporarily store various data, and/or EEPROM (“Electrically Erasable PROM”) provided to store data which are read or rewritten by contactless card 310.

As shown in FIG. 3B, a detailed block diagram 300B illustrates contactless card 310 which may alternatively be designed with battery 330 instead of power rectifier 326. It should be understood that in such a case the maximum operating distance between the contactless card 310 and card reader is greater than when power is supplied to contactless card 310 by power rectifier 326. The reason being that the response signal transmitted from the card to the reader will typically be stronger when generated by a reader employing its own power supply. Of course, the benefit of generating power from the H-Field as opposed to having a separate power supply is that the contactless card can be manufactured without the additional power supply component, such as a battery.

In operation of contactless card 310 of either embodiment, once the carrier signal is detected by RF interface 312, this carrier signal is provided to card module 314. Clock recovery device 318 in conjunction with the other components of RF interface 312 enables contactless card 310 to receive and process the higher frequency carrier signal transmitted by reader 130. The demodulating circuit 320 is provided to demodulate the carrier signal and is coupled to microprocessor 316. Applying the demodulated data, microprocessor 316 in turn can write and/or read data to and from memory 324 in accordance with the application as controlled by the card's software.

Microprocessor 316 is further coupled to modulating circuit 322, which is configured to modulate a response signal on the carrier signal. In operation, contactless card 310 employs signal generator device 332, which includes phase-locked loop 328, and is coupled to clock recovery device 318 and modulating circuit 322. At the same that RF interface 312 is receiving the high frequency carrier signal, RF interface 312 may also be concurrently detecting the first signal transmitted from the reader.

In one embodiment, contactless card 310 utilizes the “crystal-accurate” frequency of this first signal to generate a response signal. As further described above in the exemplary embodiment, this signal can have an operating frequency of 13.56 MHz. Accordingly, in a manner similar to that of reader 230, contactless card 310 inputs the first frequency of the first signal to phase-locked loop 328, which can then generate a second frequency for the response signal. Signal generator device 332 can then generate a carrier operating at the second “crystal-accurate” frequency and modulating circuit 322 can modulate data onto the carrier operating at this second frequency to provide a response signal.

This response signal can then be transmitted back to the card reader via RF interface 312 of contactless card 310. Because contactless card 310 is generating the response signal from the “crystal-accurate” first frequency of the first signal transmitted by the reader, contactless card 310 is capable of transmitting a response signal with an operating frequency in the microwave frequency range, which is also “crystal-accurate”. Accordingly, contactless card 310 is also capable of transmitting data as response signals to the reader at high speeds, such as those of Wi-Fi or USB, and, therefore, capable of transmitting data at 100 Mbit/s or faster. It is reiterated that the frequencies described above with respect to the exemplary embodiment are not intended to limit the application in any way. Rather, any frequencies may be implemented that are deemed suitable by the system designer for the intended purpose.

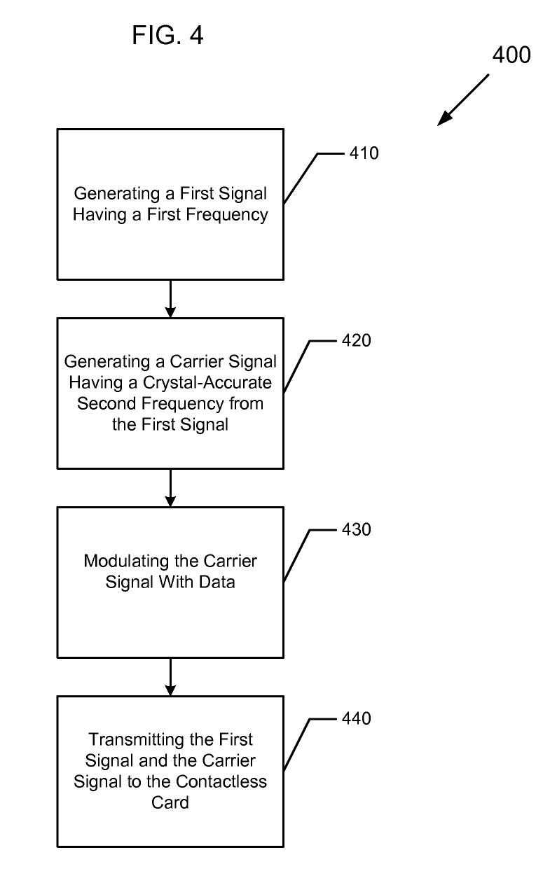

FIG. 4 shows a flowchart of a method for high speed communication 400 in accordance with an embodiment of the present invention, and more specifically, for high speed communication between contactless card 310 and card reader 230. In Step 410, crystal oscillator 240 of card reader 230 generates a first signal having a first frequency, for example 13.56 MHz, that is “crystal-accurate”. Next, at Step 420, signal generator device 236 generates a carrier signal having a second frequency from the first signal using phase-locked loop 238. The frequency of the carrier signal will also be “crystal-accurate”, and is higher than the first frequency, as discussed in detail above. At Step 430, modulating device 242 modulates the carrier signal with data received from microprocessor 244 and, at Step 440, RF interface 232 transmits the first signal and carrier signal to the contactless card.

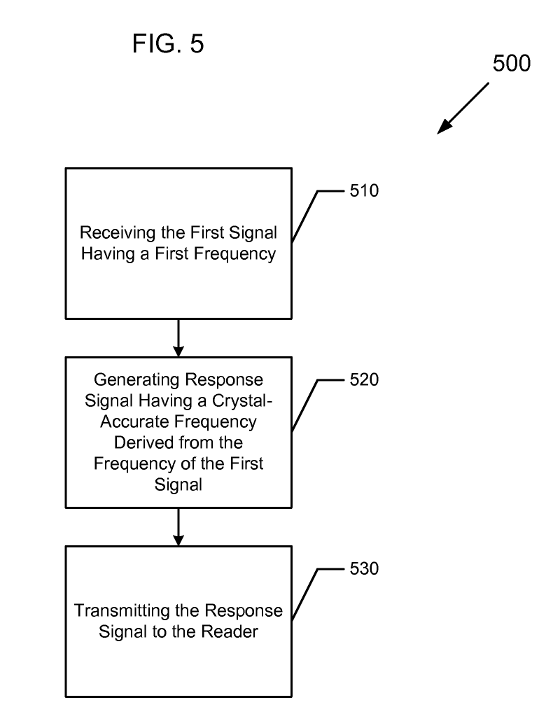

FIG. 5 shows a flowchart of a method for high speed communication 400 in accordance with an embodiment of the present invention, and more specifically, for contactless card 310 generating and transmitting a response signal to card reader 230 at high speeds. Specifically, contactless card 310 receives from the card reader 230 the first signal having a first frequency at Step 510. Next, at Step 520, contactless card 310 generates a response signal using phase-locked loop 328 in conjunction with signal generator device 332. Subsequently, this response signal is transmitted back to the card reader 230 by RF interface 312 (Step 530). Accordingly, because the response signal is derived from the first signal having a crystal-accurate first frequency, the second frequency can operate in the microwave frequency range, for example. As should be clear from the aforementioned discussion, this communication is capable of being performed at high speeds in the range of data transmission speeds defined by standards such as Wi-Fi, USB, etc. Accordingly, data can be transmitted between contactless card 310 and card reader 230 at a rate of 100 Mbit/s or faster.

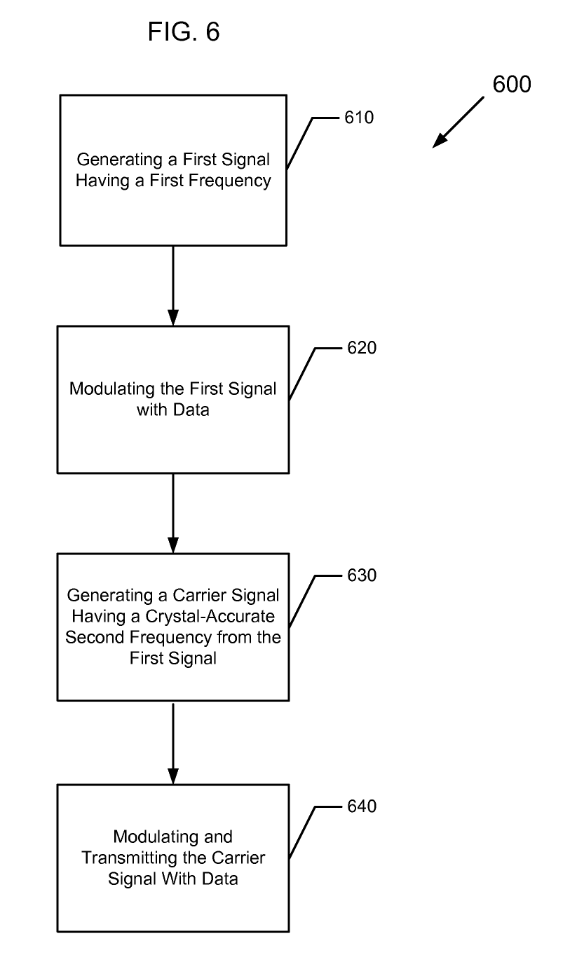

Finally, FIG. 6 shows a flowchart for a method for high speed communication 500 between contactless card 410 and card reader 230 wherein the communication system is operating in hybrid mode. In Step 610, crystal oscillator 240 of card reader 230 generates the first signal having a first frequency, for example, 13.56 MHz, which is “crystal-accurate”. At Step 620, modulating circuit 322 modulates data on the first signal. At Step 630, signal generator device 236 generates a carrier signal having a second frequency from the first signal using phase-locked loop 238. Again, the frequency of the carrier signal will also be “crystal-accurate”, and is higher than the first frequency. The invention is not limited to Step 630 occurring after Steps 610 and 620. Step 630 may occur during Step 610 and/or Step 620. At Step 640, modulating device 242 modulates and transmits the carrier signal with data received from microprocessor 244 using protocol extensions, which may be defined by software updates. As discussed above, communication using the carrier signal can be performed at high speeds such as 100 Mbit/s or faster.

While the foregoing has been described in conjunction with an exemplary embodiment, it is understood that the term “exemplary” is merely meant as an example, rather than the best or optimal. Accordingly, the application is intended to cover alternatives, modifications and equivalents, which may be included within the spirit and scope of the invention.

Additionally, in the preceding detailed description, numerous specific details have been set forth in order to provide a thorough understanding of the present invention. However, it should be apparent to one of ordinary skill in the art that the present invention may be practiced without these specific details. In other instances, well-known methods, procedures, components, and circuits have not been described in detail so as not to unnecessarily obscure aspects of the present invention.

1. A contactless reader comprising:
a crystal oscillator configured to generate a first signal having a first frequency;
a phase-locked loop configured to generate a crystal-accurate second frequency derived from the first frequency of the first signal; and
a signal generator configured to generate a carrier signal having the crystal-accurate second frequency.

2. The contactless reader of claim 1, further comprising a modulator configured to modulate data onto the carrier signal.

3. The contactless reader of claim 1, wherein the second frequency is greater than the first frequency.

4. The contactless reader of claim 1, wherein the first frequency is in the High Frequency (HF) range.

5. The contactless reader of claim 1, further comprising a demodulator configured to demodulate data from a response signal transmitted by a contactless card.

6. The contactless reader of claim 1, wherein the second frequency is in the microwave frequency range.

7. The contactless reader of claim 1, wherein the first signal can be used to supply power to a contactless card.

8. The contactless reader of claim 2, wherein the modulator is further configured to modulate data onto the first signal prior to modulating data on the carrier signal.

9. A contactless card comprising:
an RF interface configured to receive a first signal having a first frequency;
a phase-locked loop configured to generate a second frequency derived from the first frequency; and
a signal generator configured to generate a response signal having the second frequency.

10. The contactless card of claim 9, further comprising a modulator configured to modulate data onto the response signal.

11. The contactless card of claim 9, wherein the first frequency and the second frequency are crystal-accurate.

12. The contactless card of claim 9, wherein the second frequency is in the microwave frequency range.

13. The contactless card of claim 9, wherein the RF interface is further configured to receive a carrier signal operating in the microwave frequency range.

14. The contactless communication system of claim 9, wherein the contactless card further comprises a rectifier configured to derive power from the first signal.

15. The contactless communication system of claim 9, wherein the contactless card further comprises a clock recovery unit coupled to the phase-locked loop, and configured to control timing of receipt and transmission of data.

16. A contactless communication system comprising:
a reader comprising:
an crystal oscillator configured to generate a first signal having a first frequency;
a first phase-locked loop configured to generate a crystal-accurate second frequency derived from the first frequency of the first signal;
a first signal generator configured to generate a carrier signal having the second frequency; and
a first modulator configured to modulate data onto the carrier signal; and
a contactless card comprising:
an antenna tuned to at least the first frequency;
a second phase-locked loop configured to derive the second frequency from the first frequency, wherein the second frequency is crystal-accurate; and
a second signal generator device configured to generate a response signal having the second frequency.

17. The contactless card of claim 16, further comprising a second modulator configured to modulate data onto the response signal.

18. The contactless communication system of claim 16, wherein the contactless card further comprises a second antenna tuned to the second frequency.

19. The contactless communication system of claim 16, wherein the second frequency is higher than the first frequency.

20. The contactless communication system of claim 16, wherein the second frequency enables the contactless reader and the contactless card to communicate at a data rate corresponding to a data rate of a USB standard.

21. The contactless communication system of claim 20, wherein the USB standard is selected from the group of USB standards consisting of USB 1.0, USB 1.1, and USB 2.0.

22. The contactless communication system of claim 16, wherein the modulator is further configured to modulate data on the first signal prior to modulating data on the carrier signal.

23. A contactless communication method comprising:
generating a first signal having a first frequency, by an crystal oscillator;
generating a carrier signal having a crystal-accurate second frequency derived from the first signal, by a phase-locked loop;
modulating data onto the carrier signal, by a modulator; and
transmitting the carrier signal to a contactless card, by an RF interface.

24. The contactless communication method of claim 23, further comprising modulating data on the first signal prior to the modulating data on the carrier signal.

25. A contactless communication method comprising:
receiving a first signal having a first frequency, by an RF interface;
generating a crystal-accurate second frequency derived from the first frequency, by a phase-locked loop;
generating a response signal having the second frequency, by a signal generator; and
transmitting the response signal to a reader by the RF interface.
